(19) United States
(12) Patent Application Publication
(10) Pub. No.: US 2005/0252818 A1
(43) Pub. Date: Nov. 17, 2005

(54) High barrier packaging film with controlled extractables

(75) Inventors: Carl E. Altman, Pitman, PA (US); David J. Gibboni, Havertown, PA (US)

Correspondence Address: Richard S. Roberts;Roberts & Roberts, L.L.P. Attorneys at Law, P.O. Box 484, Princeton, NJ, 08542-0484, US

(73) Assignee: HONEYWELL INTERNATIONAL, INC.

(21) Appl. No.: 10/842,861

(22) Filed: May 11, 2004

(51) Int. Cl. B32B 27/08; B32B 27/32; B65D 1/09

(52) U.S. Cl. 206/528; 428/421; 428/523; 428/422; 428/35.7; 156/244.11; 264/173.12

(57) ABSTRACT

Coextruded or laminated multilayer films are provided having at least one layer of a fluoropolymer homopolymer or copolymer, a layer of a high-pressure, low-density polyethylene and an intermediate adhesive tie layer. Such barrier films substantially reduce the leaching of contaminants barrier film into a packaged product, or are completely leach resistant.

### BACKGROUND OF THE INVENTION

1. Field of the Invention

The present invention relates to multilayer films. More particularly, the invention pertains to coextruded or laminated barrier films having at least one layer of a fluoropolymer homopolymer or copolymer, a layer of a high-pressure, low-density polyethylene and an intermediate adhesive layer between said layers. Such multilayer films substantially reduce or eliminate the extraction of contaminants from the barrier film into a packaged product.

2. Description of the Related Art

A wide variety of thermoplastic polymers and films formed from thermoplastic polymers are known. Important physical characteristics of such films include its barrier properties, including barriers to gas, aroma, and/or vapor such as water vapor, as well as its physical characteristics, such as toughness, wear and weathering resistances, and light-transmittance. These properties are especially important in film applications such as, for example, in the use of films as a packaging material for food or medical products.

It is well known in the art to produce single layer and multilayer fluoropolymer films. See, for example, U.S. Pat. Nos. 4,146,521; 4,659,625; 4,677,017; 5,139,878; 5,855,977; 6,096,428; 6,138,830; and 6,197,393 which are incorporated herein by reference. Many fluoropolymer materials are commonly known for their excellent moisture and vapor barrier properties, and therefore are desirable components of packaging films, particularly lidding films and blister packages. In addition, fluoropolymers exhibit high thermal stability and excellent toughness. However, such use of fluoropolymers is restricted to specialty packaging applications due to their relatively high cost. A suitable means of reducing the cost of a packaging material fabricated from a costly polymer is to form multilayer structures in which the polymer film is laminated with other, less costly polymer films. This approach is particularly desirable for the fluoropolymer packaging applications since a thin layer of the fluoropolymer is often all that is needed to take advantage of the desirable properties of the fluoropolymer while minimizing the cost. However, fluoropolymers do not adhere strongly to most other polymers.

To improve the bond strength between a layer of a fluoropolymer and a layer of a thermoplastic polymer (e.g. a non-fluoropolymer containing layer), an adhesive tie layer may be used between adjacent layers. For example, U.S. Pat. No. 4,677,017 discloses coextruded multilayer films which include at least one fluoropolymer film and at least one thermoplastic film which are joined by the use of an adhesive polymer, particularly ethylene/vinyl acetate polymers, as an adhesive tie layer. U.S. Pat. No. 4,659,625 discloses a fluoropolymer multilayer film structure which utilizes a vinyl acetate polymer adhesive tie layer. U.S. Pat. No. 5,139,878, discloses a fluoropolymer film structure using an adhesive tie layer of modified polyolefins. U.S. Pat. No. 6,451,925, which is incorporated herein by reference, teaches a laminate of a fluoropolymer containing layer and a non-fluoropolymer containing layer using an adhesive tie layer which is a blend of an aliphatic polyamide and a fluorine-containing graft polymer. Additionally, U.S. Pat. No. 5,855,977 teaches applying an aliphatic di- or polyamine to one or more surfaces of a fluoropolymer or non-fluoropolymer material layer.

In some fluoropolymer film applications or applications of multilayer films containing fluoropolymers, e.g. blister packaging applications, it is desirable to orient the film. Blister packaging is a packaging application that enables the consumer to see a product enclosed in clear plastic. Typically a clear or transparent plastic dome or bubble is preformed and attached to a paperboard (or other carrier) base, to encase the product. The product is then typically forced out of the blister package by pushing it through the paperboard. In forming the push through plastic film used to blister package pharmaceuticals, it is desired to monoaxially orient the film in order to achieve one direction push through of the product. For high strength lidding, a biaxially oriented film would be desired. As an added benefit, orientation of fluoropolymer films has been found to result in an even greater degree of moisture and vapor barrier properties above the standard fluoropolymer barrier properties.

U.S. Pat. No. 4,510,301, which is incorporated herein by reference, discloses oriented films containing a copolymer of 40 to 60 mole percent ethylene and chlorotrifluoroethylene. U.S. Pat. No. 4,519,969, which is incorporated herein by reference, discloses a biaxially stretched film and a method for the manufacture thereof, containing at least 90 mole % of ethylene-tetrafluoroethylene copolymer. U.S. Pat. No. 4,677,017 discloses coextruded multilayer films which include a fluoropolymer and a thermoplastic film which are joined by the use of an adhesive polymer. U.S. Pat. No. 4,659,625 discloses a fluoropolymer multilayer film structure which utilizes a vinyl acetate polymer adhesive layer. U.S. Pat. No. 5,139,878 discloses a fluoropolymer film structure using an adhesive layer of modified polyolefins.

Unfortunately, a considerable problem that has been recognized with known multilayered fluoropolymer barrier films, particularly those used for packaging of pharmaceuticals, food products or chemicals, is that additives or residual chemicals contained in the film layers can leach out of the film and into the packaged material. This contamination leads to the damage or destruction of the packaged product. Accordingly, a multilayered packaging film structure that is leach resistant or minimizes the leaching or extraction of contaminants from the film into a packaged product is desired.

It has been found that multilayer packaging films containing at least one fluoropolymer containing layer and at least one high-pressure, low-density polyethylene containing layer satisfies this need in the art. High-pressure, low-density polyethylenes are polyethylenes that are obtained by polymerizing ethylene at high temperatures under high pressures. They are described, for example, in U.S. Pat. Nos. 5,741,861 and 5,756,193, which are incorporated herein by reference. It has been found that the high-pressure, low-density polyethylene, when positioned as the innermost film layer which is in contact with the packaged product, will deter the leaching of contaminants from other film layers, protecting the product.

### SUMMARY OF THE INVENTION

The invention provides a multilayered film which comprises at least one fluoropolymer containing layer and at least one high-pressure, low-density polyethylene containing layer attached to a surface of said fluoropolymer containing layer by an intermediate adhesive layer.

The invention also provides a method of producing a multilayered film which comprises coextruding and attaching at least one fluoropolymer containing layer to a surface of at least one high-pressure, low-density polyethylene containing layer such that the polyethylene layer is attached to a surface of the fluoropolymer containing layer by a coextruded intermediate adhesive layer.

The invention further provides a method of producing a multilayered film which comprises laminating and attaching at least one fluoropolymer containing layer to a surface of at least one high-pressure, low-density polyethylene containing layer by an intermediate adhesive layer.

The invention still further provides articles and packages formed from the multilayered films of the invention, as well as packaged products contained in containers formed from the multilayered films of the invention.

### DETAILED DESCRIPTION OF THE PREFERRED EMBODIMENT

The invention provides a film which comprises at least one fluoropolymer containing layer and at least one high-pressure, low-density polyethylene containing layer attached to a surface of the fluoropolymer containing layer by an intermediate adhesive layer.

The fluoropolymer containing layer has first and second surfaces and is joined with an adhesive tie layer such that the first surface of the fluoropolymer containing layer is in contact with a first surface of the adhesive tie layer. Fluoropolymer materials are commonly known for their excellent chemical resistance and release properties as well as moisture and vapor barrier properties, and therefore are desirable components of packaging films. In the preferred embodiment of the invention, the fluoropolymer containing layer may be comprised of fluoropolymer homopolymers or copolymers or blends thereof as are well known in the art and are described in, for example, U.S. Pat. Nos. 4,510,301, 4,544,721 and 5,139,878 which are incorporated herein by reference. Preferred fluoropolymers include, but are not limited to, homopolymers and copolymers of chlorotrifluoroethylene, ethylene-chlorotrifluoroethylene copolymer, ethylene-tetrafluoroethylene copolymer, fluorinated ethylene-propylene copolymer, perfluoroalkoxyethylene, polychlorotrifluoroethylene, polytetrafluoroethylene, polyvinyl fluoride, polyvinylidene fluoride, and copolymers and blends thereof. As used herein, copolymers include polymers having two or more monomer components. The most preferred fluoropolymers include homopolymers and copolymers of poly(chlorotrifluoroethylene). Particularly preferred are PCTFE (polychlorotrifluoroethylene homopolymer) materials sold under the ACLON™ trademark and which are commercially available from Honeywell International Inc. of Morristown, New Jersey.

Adjacent to the fluoropolymer containing layer is an adhesive layer, also referred to in the art as a “tie” layer, between each film layer. Any suitable adhesive tie layer as known in the art may be employed in accordance with the present invention. Such adhesives include, but are not limited to, polyurethanes, epoxies, polyesters, acrylics, polyolefin plastomers, functionally modified polyolefins such as anhydride modified polyolefins and blends thereof. Modified polyolefin compositions have at least one functional moiety selected from the group consisting of unsaturated polycarboxylic acids and anhydrides thereof. Such unsaturated carboxylic acid and anhydrides include maleic acid and anhydride, fumaric acid and anhydride, crotonic acid and anhydride, citraconic acid and anhydride, itaconic acid an anhydride and the like. Of these, the most preferred is maleic anhydride. Also preferred are blends of polyolefin plastomers and functionally modified polyolefins. The modified polyolefins suitable for use in this invention include compositions described in U.S. Pat. Nos. 3,481,910; 3,480,580; 4,612,155 and 4,751,270 which are incorporated herein by reference. Other adhesive layers non-exclusively include alkyl ester copolymers of olefins and alkyl esters of α,β-ethylenically unsaturated carboxylic acids such as those described in U.S. Pat. No. 5,139,878. The preferred modified polyolefin composition comprises from about 0.001 and about 20 weight percent of the functional moiety, based on the total weight of the modified polyolefin. More preferably the functional moiety comprises from about 0.05 and about 10 weight percent, and most preferably from about 0.1 and about 5 weight percent. The modified polyolefin composition may also contain up to about 40 weight percent of thermoplastic elastomers and alkyl esters as described in U.S. Pat. No. 5,139,878.

Adjacent the adhesive layer is a layer of a high-pressure, low-density polyethylene. Such are described, for example, in U.S. Pat. Nos. 5,741,861 and 5,756,193 which are incorporated herein by reference. High-pressure, low-density polyethylenes are obtained by polymerizing ethylene at high temperatures and under high pressures using a free-radical initiator. For example, the radical polymerization process may be conducted at a pressure of from about 1,000 atm to about 3,000 atm and a temperature of 80° C. to 300° C. A free radical initiator such as benzoyl peroxide, azodi-isobutyronitrile or oxygen is commonly used. The process may be operated continuously by passing the reactants through narrow bore tubes or through stirred reactors or by a batch process in an autoclave reactor. Such processes are well known in the art.

The high-pressure polymerization process is a homogenous process and does not require the use of supported catalysts. This is important to the invention because in a catalyzed process the catalyst becomes degraded, thus a stabilizer compound is required to stabilize the polymer. When the polymer is subsequently formed into a film, the stabilizer in the polymer has been found to leach out of the polymer film and into the packaged product. On the other hand, high-pressure, low density polyethylenes formed using the high-pressure process are catalyzed by the high pressures and high temperatures and do not require a separate catalyst. Thus, no stabilizer is used. Since the resulting polyethylene was not formed using a stabilizer composition, there is no stabilizer present to potentially leach into a packaged product from a subsequently formed packaging film. Further description of the high-pressure polymerization process is described at pages 189-191 of Plastics Materials, 4th Ed., published by Butterworth Scientific, (J. A. Brydson, Plastics Materials. London: Butterworth Scientific, 1982, pp. 189-191.), which is incorporated herein by reference.

The polymerized high-pressure, low-density polyethylenes of the invention are polyethylene polymers having long-chain pendant branches, usually polymers whose pendant branches have at least about 20 carbon atoms. The preferred high-pressure, low-density polyethylenes of the invention are further characterized by melting points in the range of from about 107° C. to about 112° C., more preferably from about 108° C. to about 111° C. and most preferably from about 109° C. to about 110° C. In the preferred embodiment of the invention, the high-pressure, low-density polyethylenes preferably have a density of from about 0.910 g/cm³ to about 0.925 g/cm³, more preferably from about 0.915 g/cm³ to about 0.924 g/cm³ and most preferably from about 0.919 g/cm³ to about 0.923 g/cm³, according to the ASTM D-1505 testing method. The high-pressure, low-density polyethylenes have a preferred melt flow index of from about 0.1 g/10 min. to about 12.0 g/10 min., more preferably from about 1 g/10 min. to about 10.0 g/10 min and most preferably from about 1.0 g/10 min to about 5.0 g/10 min, according to the ASTM D-1238 testing method. In the preferred embodiment of the invention, the high-pressure, low-density polyethylenes are formed at a processing temperature of from about 325° C. to about 375° C., more preferably from about 335° C. to about 365° C. and most preferably from about 345° C. to about 355° C. Also, in order to maximize the protection of a packaged product from any contaminants, it is particularly preferred that high-pressure, low-density polyethylene layers of multilayered films of the invention are substantially devoid of contaminants capable of leaching out of the layer, and preferably contain no additives, such as, for example, heat stabilizers, antioxidants, secondary stabilizers, slip agents, antiblocking agents, UV Stabilizers and flame retardants. It is most preferred that each of the high-pressure, low-density polyethylene containing layer, fluoropolymer containing layer and intermediate adhesive layer are substantially devoid of such contaminants which are potentially capable of leaching out of said layers.

Preferred high-pressure, low-density polyethylenes may be obtained commercially, such as from Exxon-Mobil Chemical Company or Chevron Phillips Chemical Company. Preferred examples include Exxon-Mobil polyethylene grades LD 102.LN, LD 110.LN, LD 120.LN, LD 123.LN, LD 202.48 and LD 516.LN. Each of these are high-pressure, low-density polyethylenes formed from a high-pressure process and do not contain an added stabilizer composition.

The multilayer films of the present invention can have a variety of structures and preferably have an adhesive layer between each individual layer. A typical film structure includes a three-layer structure, which comprises a high-pressure, low-density polyethylene containing layer, an adhesive layer and a fluoropolymer containing layer. Another typical film structure is a five-layer structure, which comprises a high-pressure, low-density polyethylene containing layer, an adhesive layer, a fluoropolymer containing layer, an adhesive layer and a high-pressure, low-density polyethylene containing layer. These are only two of many possible combinations of multilayer film structures, and any variation of the order and thickness of the layers of the fluoropolymer and high-pressure, low-density polyethylene can be made. Optional additional layers may comprise a thermoplastic polymer layer such as a polyolefin, e.g. a polyethylene or polypropylene homopolymer or copolymer, a polyester, a polyolefin, a vinyl ester, polyamide, polyvinyl chloride, polyvinylidene chloride, poly(acrylonitrile) homopolymer or copolymer, polyvinyl alcohol or ethylene vinyl alcohol. The polymeric layers of the invention may also be attached to one or more metal foil layers, such as an aluminum foil. Such films are well known in the art. Any additional layers may be added via well known lamination, coextrusion or coating techniques. It should be known, however, that should multilayered films be formed that have additional optional layers as discussed herein, the high-pressure, low-density polyethylene containing layer is preferably the innermost film layer of the barrier film, being in contact with the packaged product.

Each of the film layers, may optionally also include one or more conventional additives whose uses are well known to those skilled in the art. The use of such additives may be desirable in enhancing the processing of the individual layer compositions as well as improving the products or articles formed therefrom. However, it is most preferred that no additives are present in the high-pressure, low-density polyethylene containing layer. Examples of such include: oxidative and thermal stabilizers, lubricants, release agents, flame-retarding agents, oxidation inhibitors, oxidation scavengers, dyes, pigments and other coloring agents, ultraviolet light absorbers and stabilizers, organic or inorganic fillers including particulate and fibrous fillers, reinforcing agents, nucleators, plasticizers, as well as other conventional additives known to the art. In the preferred embodiment, all of the layers of the multilayered film are substantially devoid of such additives. When additives are used, such may be used in amounts, for example, of up to about 10% by weight of the overall layer composition. Representative ultraviolet light stabilizers include various substituted resorcinols, salicylates, benzotriazole, benzophenones, and the like. Suitable lubricants and release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benylnesulfonamide, and combinations of any of the above, as well as other plasticizers known to the art.

The multilayer films of this invention may be produced by conventional methods useful in producing multilayer films, including coextrusion and lamination techniques that are well known in the art. Suitable coextrusion techniques are described in U.S. Pat. Nos. 5,139,878 and 4,677,017. One advantage of coextruded films is the formation of a multilayer film in a one process step by combining molten layers of each of the film layers of fluoropolymer, tie layer composition, and high-pressure, low-density polyethylene containing layer, as well as optionally more film layers, into a unitary film structure. In order to produce a multilayer film by a coextrusion process, it is necessary that the constituents used to form each of the individual films be compatible with the film extrusion process. The term “compatible” in this respect means that the film-forming compositions used to form the films have melt properties which are sufficiently similar so as to allow coextrusion. Melt properties of interest include, for example, melting points, melt flow indices, apparent viscosity, as well as melt stability. It is important that such compatibility be present to assure the production of a multilayer film having good adhesion and relatively uniform thickness across the width of the film being produced. As is known in the art, film-forming compositions, which are not sufficiently compatible to be useful in a coextrusion process frequently produce films having poor interfacial lamination, poor physical properties as well as poor appearance.

One skilled in the art can readily weigh the above-noted compatibility in order to select polymers having desirable physical properties and determine the optimal combination of relative properties in adjacent layers without undue experimentation. If a coextrusion process is used, it is important that the constituents used to form the multilayer film be compatible within a relatively close temperature range in order to permit extrusion through a common die. The coextruded film may be cast onto a casting roller or blown as a bubble which is then collapsed, using techniques well known in the art.

Alternatively, the multilayer films of the present invention can be produced by lamination whereby a multilayer film structure is formed from pre-fabricated film plies. Typically, laminating is done by positioning the individual layers of the inventive film on one another under conditions of sufficient heat and pressure to cause the layers to combine into a unitary film. Typically the fluoropolymer, adhesive, and high-pressure, low-density polyethylene containing layers are positioned on one another, and the combination is passed through the nip of a pair of heated laminating rollers by techniques well known in the art such as those described in U.S. Pat. No. 3,355,347 which is incorporated herein by reference. Lamination heating may be done at temperatures ranging from about 120° C. to about 175° C., preferably from about 150° C. to about 175° C. at pressures ranging from about 5 psig (0.034 MPa) to about 100 psig (0.69 MPa) for from about 5 seconds to about 5 minutes, preferably from about 30 seconds to about 1 minute.

The multilayer film, whether comprising or three or more layer structure, may be stretched or oriented in any desired direction using methods well known to those skilled in the art. For purposes of this invention, the terms “orienting” and “stretching” shall be used interchangeably. Examples of such methods include those set forth in U.S. Pat. No. 4,510,301. In such a stretching operation, the film may be stretched uniaxially in either the direction coincident with the direction of movement of the film being withdrawn from the casting roll, also referred to in the art as the “machine direction”, or in as direction which is perpendicular to the machine direction, and referred to in the art as the “transverse direction”, or biaxially in both the machine direction and the transverse direction. We have found that the fluoropolymer films of the present invention have sufficient dimensional stability to be stretched at least about 1.5 and preferably from about 1.5 to about 10 times in either the machine direction or the transverse direction or both.

Although each layer of the multilayer film structure may have a different thickness, the thickness of each of the fluoropolymer and high-pressure, low-density polyethylene containing layers of the films in the post-stretched multilayer films structure is preferably from about 0.05 mils (1.3 μm) to about 100 mils (2540 μm), and more preferably from about 0.05 mils (1.3 μm) to about 50 mils (1270 μm). The thickness of the post-stretched adhesive layer may vary, but is generally in the range of from about 0.02 mils to about 12 mils (305 μm), preferably from about 0.05 mils (1.3 μm) to about 1.0 mils (25 μm), and most preferably from about 0.1 mils (25 μm) to about 0.8 mils (20 μm). While such thicknesses are preferred as providing a readily flexible film, it is to be understood that other film thicknesses may be produced to satisfy a particular need and yet fall within the scope of the present invention; such thicknesses which are contemplated include plates, thick films, and sheets which are not readily flexible at room temperature (approx. 20° C.).

The multilayered packaging films of the invention are superior to other known packaging films because they substantially reduce or entirely prevent the leachability of contaminants from the film into a packaged product. Particularly, the multilayered packaging films of the invention have been found to exhibit a leachability amount of less than about 1.0 parts per million (ppm), more preferably less than about 0.5 ppm and most preferably less than about 0.1 ppm of leachables as determined by conventional testing methods. Another noteworthy characteristic of the films of the present invention is that they exhibit improved tensile modulus, mechanical strength, and the most significantly of all, excellent barrier properties towards both water vapor and oxygen after being stretched. With these composite films, the degree of attainable water vapor barrier properties is significantly improved without increasing the film gauge. The multilayered films of the invention exhibit high sealability, exhibiting a seal strength of from about 0.5 lb/in to about 4 lb/in, more preferably from about 1 lb/in to about 4 lb/in and most preferably from about 1.5 lb/in to about 4 lb/in using a standard bar seal testing method. The multilayered films of the invention also exhibit a haze percentage of preferably less than about 10%, more preferably less than about 5%.

The water vapor transmission rate (WVTR) of the films of the invention may be determined via the procedure set forth in ASTM F1249. In the preferred embodiment, the overall multilayered film according to this invention has a WVTR of from about 0.1 or less gm/100 in²/day of the overall film at 37.8° C. and 100% RH, preferably from 0.001 to about 0.07 gm/100 in²/day of the overall film, and more preferably from 0.001 to about 0.04 gm/100 in²/day of the overall film.

The oxygen transmission rate (OTR) of the films of the invention may be determined via the procedure of ASTM D-3985 using an OX-TRAN 2/20 instrument manufactured by Modem Controls, Inc., operated at 23° C., 0% RH. In the preferred embodiment, the overall multilayered film according to this invention has an OTR of from about 50 or less cc/100 in²/day of the overall film preferably from about 0.001 to about 20 cc/100 in²/day of the overall film, and more preferably from about 0.001 to about 10 cc/100 in²/day of the overall film.

The multilayered films of the invention are particularly useful for forming thermoformed three dimensionally shaped articles such as rigid or soft blister packaging with peelable or push through lidding for pharmaceuticals or other products or materials. This may be done by forming the film around a suitable mold and heating in a method well known in the art. The thermoformed film may then be adjoined by coating, lamination or another suitable method with other films, foils or other materials to form a sealed or a sealable package. The multilayered films of the invention are also particularly useful for forming transparent or opaque pouches, sachets and overwraps that may be formed, filled with a product and sealed. Examples of suitable products include, but are not limited to, liquids including water-based, alcohol-based and organic solvent-based solutions, assorted solid objects, powders, pharmaceuticals, nutraceuticals, devices such as sutures, catheters, test kits, etc.

The following non-limiting examples serve to illustrate the invention.

### EXAMPLE 1 (COMPARATIVE)

A three-layer multilayered film was formed having a 2.0 mil thick layer of HL Aclon® fluoropolymer, commercially available from Honeywell International Inc., attached to a 2.0 mil thick layer of Marlex® D350 grade polyethylene, commercially available from Exxon Mobil Chemical Company, with a 0.5 mil thick intermediate tie layer having no tackifier. Marlext D350 grade polyethylene is produced with a stabilizer composition and not produced by the high pressure polymerization process according to the invention.

The polyethylene was processed in a 3.5″ screw extruder using a standard polyethylene screw with five mixing zones heated to 430° F., 450° F., 460° F., 460° F. and 460° F. respectively. The Aclon® fluoropolymer was processed using a 2.0″ screw against a casting roll with three mixing zones heated to 580° F., 540° F. and 540° F. respectively, and one adapter zone also set at 540° F. The tie layer was processed using a 1.25″ general screw extruder with three heating zones set at 120° F., 350° F. and 500° F. respectively, with an adapter zone set at 540° F. Three combining adapter zones were set at 460° F., 520° F. and 520° F. Each of the dies were set at 520° F., the cast roll temperature was 65° F. and the cool roll and heat set roll were each set at 100° F.

### EXAMPLE 2 (COMPARATIVE)

A multilayered film produced according to Example 1 is formed into a package and tested for leaching of stabilizer. The package shows an unacceptable quantity of stabilizer contaminant that leaches out of the polyethylene.

### EXAMPLE 3

Example 1 was repeated except the polyethylene layer was a 2.0 mil thick layer of LD 123 LN grade high-pressure, low density polyethylene, commercially available from Exxon Mobil Chemical Company.

### EXAMPLE 4

A multilayered film produced according to Example 3 is formed into a package and tested for leaching of stabilizer. The package shows no measurable stabilizer contaminant that leaches out of the polyethylene.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A multilayered film which comprises at least one fluoropolymer containing layer and at least one high-pressure, low-density polyethylene containing layer attached to a surface of said fluoropolymer containing layer by an intermediate adhesive layer.

2. The multilayered film of claim 1 wherein said high-pressure, low-density polyethylene containing layer is substantially devoid of contaminants capable of leaching out of said high-pressure, low-density polyethylene containing layer.

3. The multilayered film of claim 1 wherein each of said high-pressure, low-density polyethylene containing layer, said fluoropolymer containing layer, and said intermediate adhesive layer are substantially devoid of contaminants capable of leaching out of said layers.

4. The multilayered film of claim 1 wherein the high-pressure, low-density polyethylene is has been produced in the absence of a stabilizer compound.

5. The multilayered film of claim 1 which high-pressure, low-density polyethylene comprises a polymer having long-chain pendant branches.

6. The multilayered film of claim 1 which high-pressure, low-density polyethylene comprises a polymer having long-chain pendant branches, which branches have at least about 20 carbon atoms.

7. The multilayered film of claim 1 which high-pressure, low-density polyethylene has a density of from about 0.910 g/cm³ to about 0.925 g/cm³.

8. The multilayered film of claim 1 which high-pressure, low-density polyethylene has a density of from about 0.915 g/cm³ to about 0.924 g/cm³.

9. The multilayered film of claim 1 which high-pressure, low-density polyethylene has a density of from about 0.919 g/cm³ to about 0.923 g/cm³.

10. The multilayered film of claim 1 which high-pressure, low-density polyethylene has a melt flow rate of from about 1.0 to about 12.0 g/10 minutes determined in accordance with the ASTM D-1238 testing method.

11. The multilayered film of claim 1 which high-pressure, low-density polyethylene has a melting temperature of from about 107° C. to about 112° C.

12. The multilayered film of claim 1 which high-pressure, low-density polyethylene has a melting temperature of from about 108° C. to about 111° C.

13. The multilayered film of claim 1 which high-pressure, low-density polyethylene has a melting temperature of from about 109° C. to about 110° C.

14. The multilayered film of claim 1 wherein said fluoropolymer is selected from the group consisting of chlorotrifluoroethylene homopolymers, chlorotrifluoroethylene containing copolymers and blends thereof.

15. The multilayered film of claim 1 wherein said fluoropolymer comprises a poly(chlorotrifluoroethylene) homopolymer or copolymer.

16. The multilayered film of claim 1 further comprising another high-pressure, low-density polyethylene containing layer attached to another surface of said fluoropolymer containing layer by another intermediate adhesive layer.

17. The multilayered film of claim 1 wherein said adhesive layer comprises at least one polyolefin having at least one functional moiety of an unsaturated carboxylic acid or anhydride thereof.

18. A method of producing a multilayered film which comprises coextruding and attaching at least one fluoropolymer containing layer to a surface of at least one high-pressure, low-density polyethylene containing layer such that the polyethylene layer is attached to a surface of the fluoropolymer containing layer by a coextruded intermediate adhesive layer.

19. The method of claim 18 further comprising coextruding and attaching another high-pressure, low-density polyethylene containing layer to another surface of said fluoropolymer containing layer by another coextruded intermediate adhesive layer.

20. The method of claim 18 which high-pressure, low-density polyethylene has been produced in the absence of a stabilizer compound.

21. The method of claim 18 which high-pressure, low-density polyethylene comprises a polymer having long-chain pendant branches.

22. The method of claim 18 which high-pressure, low-density polyethylene comprises a polymer having long-chain pendant branches, which branches have at least about 20 carbon atoms.

23. The method of claim 18 which high-pressure, low-density polyethylene has a density of from about 0.910 g/cm³ to about 0.925 g/cm³.

24. The method of claim 18 which high-pressure, low-density polyethylene has a melt flow rate of from about 1.0 to about 12.0 g/10 minutes determined in accordance with the ASTM D-1238 testing method.

25. The method of claim 18 wherein said fluoropolymer comprises a poly(chlorotrifluoroethylene) homopolymer or copolymer.

26. The method of claim 18 further comprising the subsequent step of uniaxially or biaxially orienting the multilayered film.

27. A method of producing a multilayered film which comprises laminating and attaching at least one fluoropolymer containing layer to a surface of at least one high-pressure, low-density polyethylene containing layer by an intermediate adhesive layer.

28. The method of claim 27 further comprising laminating and attaching another high-pressure, low-density polyethylene containing layer to another surface of said fluoropolymer containing layer by another intermediate adhesive layer.

29. The method of claim 27 wherein the high-pressure, low-density polyethylene is been produced in the absence of a stabilizer compound.

30. The method of claim 27 which high-pressure, low-density polyethylene comprises a polymer having long-chain pendant branches.

31. The method of claim 27 which high-pressure, low-density polyethylene comprises a polymer having long-chain pendant branches, which branches have at least about 20 carbon atoms.

32. The method of claim 27 which high-pressure, low-density polyethylene has a density of from about 0.910 g/cm³ to about 0.925 g/cm³.

33. The method of claim 27 which high-pressure, low-density polyethylene has a melt flow rate of from about 1.0 to about 12.0 g/10 minutes determined in accordance with the ASTM D-1238 testing method.

34. The method of claim 27 wherein said fluoropolymer comprises a poly(chlorotrifluoroethylene) homopolymer or copolymer.

35. The method of claim 27 further comprising the subsequent step of uniaxially or biaxially orienting the multilayered film.

36. An article which is thermoformed from the multilayered film of claim 1.

37. A blister package which is formed from the multilayered film of claim 1.

38. A pouch which is formed from the multilayered film of claim 1.

39. A packaged food product which comprises a food contained in a container formed from the multilayered film of claim 1.

40. A packaged pharmaceutical product which comprises a pharmaceutical contained in a container formed from the multilayered film of claim 1.
